(19) United States
(12) Patent Application Publication
(10) Pub. No.: US 2006/0140448 A1
(43) Pub. Date: Jun. 29, 2006

(54) Image capturing apparatus and navigation system

(75) Inventors: Katsuya Fujii, Osaka (JP); Atsushi Yamanishi, Tokyo (JP); Hiroshi Ogino, Osaka (JP); Genzo Ohno, Osaka (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/243,221

(22) Filed: Oct. 4, 2005

(30) Foreign Application Priority Data
Dec. 27, 2004 (JP) JP2004-376411

(51) Int. Cl. G06K 9/00; G01C 21/36

(52) U.S. Cl. 382/104; 701/200

(57) ABSTRACT

The present invention provides a portable image capturing apparatus having also a navigation function while preventing increase in the size and manufacturing cost of the apparatus. As a part for displaying a guide screen of a navigation system, a rear LCD capable of displaying a high-definition image of an image capturing apparatus which can be carried by a user is used. In other words, a part in which a display of a car navigation system is formed can be separated from the car navigation system and used as a digital camera. Therefore, only by connecting the image capturing apparatus to a car navigation system body in a data transmittable/receivable manner without providing most of functions necessary for car navigation for the image capturing apparatus, the car navigation system is formed.

This application is based on application No. 2004-376411 filed in Japan, the contents of which are hereby incorporated by reference.

### BACKGROUND OF THE INVENTION

1. Field of the Invention

The present invention relates to an image capturing apparatus which can be carried by a user.

2. Description of the Background Art

In recent years, digital cameras are being widely spread. In the digital camera, the size of a liquid crystal display and the number of pixels are increasing and a high-definition image can be displayed.

By providing a monitor with a solid-state image capturing device camera, a car navigation system having the functions of a digital camera is being proposed (e.g., Japanese Patent Application Laid-Open No. 2002-71356).

In the car navigation system proposed in the above publication, however, an image capturing part is fixed to a monitor which is fixed in a car, so that usability of the system as an image capturing apparatus is poor. Further, when the case where the image capturing apparatus is used as a portable image capturing apparatus is considered, there are problems such that the size of the image capturing apparatus is large and the manufacturing cost is high due to parts necessary for the car navigation system.

### SUMMARY OF THE INVENTION

The present invention is directed to an image capturing apparatus which can be carried by a user.

According to the present invention, the image capturing apparatus includes: an image capturing part for capturing an image of a subject; an image storage part for storing a captured image which is captured by the image capturing part; an image display part for displaying the captured image stored in the image storage part; and a connection part for setting a connection state where the image capturing apparatus is connected to a predetermined navigation system body so as to be able to receive data from the predetermined navigation system body. In the connection state, the image display part functions as a guide screen display part for displaying a guide screen of a navigation system.

By using the image display part of the image capturing apparatus which can be carried by the user as the part of displaying a guide screen of the navigation system, while preventing increase in the size and manufacturing cost of the apparatus, the portable image capturing apparatus which also has the navigation function can be provided.

The present invention is also directed to a navigation system.

Therefore, an object of the present invention is to provide a technique capable of realizing a portable image capturing apparatus which has also the navigation function while preventing increase in the size and manufacturing cost of the apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing the outside configuration of an image capturing apparatus according to a preferred embodiment of the present invention;

FIG. 2 is a perspective view showing the outside configuration of the image capturing apparatus according to the preferred embodiment of the present invention;

FIG. 3 is a bottom view showing the outside configuration of the image capturing apparatus according to the preferred embodiment of the present invention;

FIG. 4 is a block diagram showing the functional configuration of the image capturing apparatus according to the preferred embodiment of the present invention;

FIG. 5 is a diagram showing the outline of a car navigation system according to a preferred embodiment of the present invention;

FIG. 6 is a diagram showing a state where the image capturing apparatus is attached to the car navigation system;

FIG. 7 is a block diagram showing the functional configuration of the car navigation system;

FIG. 8 is a diagram showing an information screen of the car navigation system;

FIG. 9 is a flowchart showing the operation flow in a car navigation mode;

FIG. 10 is a flowchart showing the operation flow in the car navigation mode;

FIG. 11 is a flowchart showing the operation flow in the car navigation mode;

FIG. 12 is a diagram showing a guide screen;

FIG. 13 is a diagram showing a guide screen including a captured picture;

FIG. 14 is a flowchart showing the operation flow in a camera mode;

FIG. 15 is a diagram showing a captured image;

FIG. 16 is a flowchart showing the operation flow in a voice navigation generating mode;

FIG. 17 is a diagram illustrating a communication function via a network;

FIG. 18 is a flowchart showing the operation flow in an image transmitting mode;

FIG. 19 is a diagram showing a screen for designating a captured image to be transmitted;

FIG. 20 is a diagram showing a screen for designating a destination of a captured picture;

FIG. 21 is a flowchart showing the operation flow of a camera mode according to a modification; and

FIG. 22 is a flowchart showing the operation flow of a car navigation mode according to the modification.

### DESCRIPTION OF THE PREFERRED EMBODIMENTS

Preferred embodiments of the present invention will be described below with reference to the drawings.

Image Capturing Apparatus

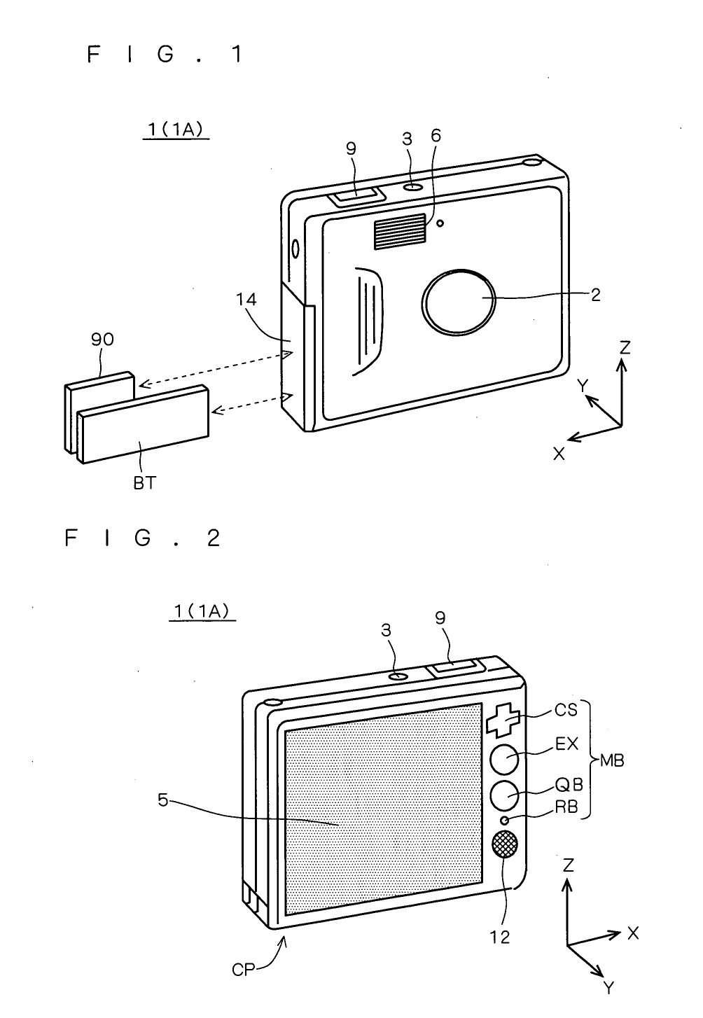

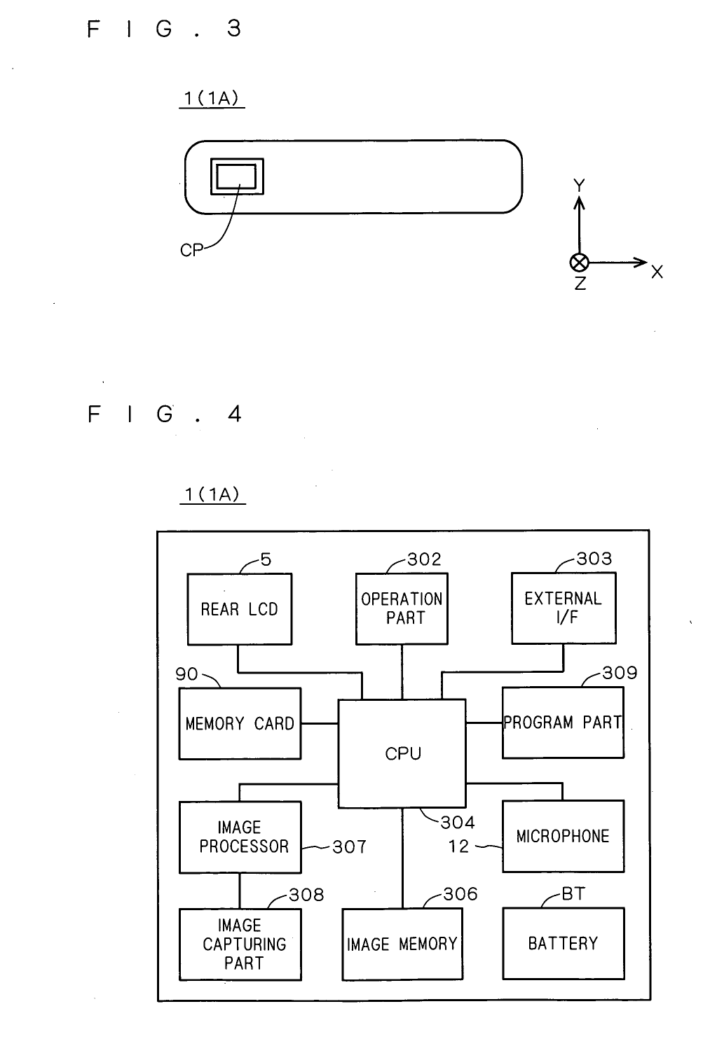

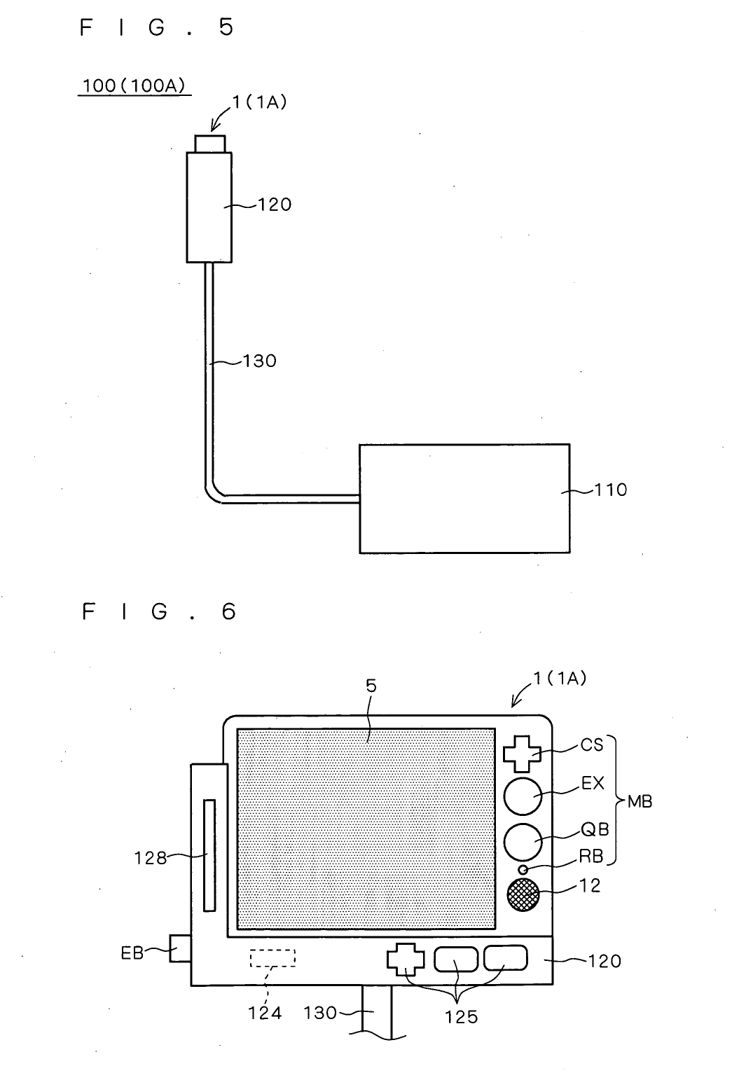

FIGS. 1 to 3 are diagrams each showing the outside configuration of an image capturing apparatus 1 according to a preferred embodiment of the present invention. FIG. 1 is a schematic perspective view seen from the front side, FIG. 2 is a schematic perspective view seen from the rear side, and FIG. 3 is a bottom view. In FIGS. 1 to 3, three axes of X, Y, and Z which are orthogonal to each other are shown in order to clarify the azimuth relations.

As shown in FIGS. 1 to 3, the image capturing apparatus 1 has a thin almost rectangular parallelepiped shape and is constructed as a digital camera which can be easily carried by the user.

As shown in FIG. 1, the image capturing apparatus 1 has a taking lens 2 and an electronic flash 6 on its front face side and has a power switch 3 and a shutter start button (release button) 9 on its top face side.

As shown in FIG. 2, the image capturing apparatus 1 has, on its rear face side, a liquid crystal display (hereinafter, referred to as “rear LCD”) 5, a rear-face operation part MB including a cross key CS, an execution button EX, a quick review button QB, and a recording button RB, and a microphone 12.

Further, as shown in FIGS. 1 and 2, the image capturing apparatus 1 has a cover 14 in its side face. The cover 14 is provided in a portion covering a battery space and a memory card slot. Specifically, the battery space for housing a power source battery BT and the memory card slot in which a memory card 90 as a removable storing medium is inserted are provided on the inner side of the cover 14. The power source battery BT and the memory card 90 are removably inserted in the battery space and the memory card slot, respectively.

As shown in FIG. 3, the image capturing apparatus 1 has, on its bottom face side, a connection part CP to be connected to a car navigation system body 110 (FIG. 5) which will be described later so that data can be transmitted/received.

As will be described later, in the image capturing apparatus 1, light from a subject is incident via the taking lens 2, an image is formed on a CCD, and the image of the subject formed on the CCD is photoelectrically converted to electric signals of R, G, and B, thereby capturing image data (captured picture) of the subject.

The power switch 3 is used for accepting the operation of turning on/off the power source. Concretely, shift to the on state and shift to the off state are alternately repeated each time the power switch 3 is depressed.

The release button 9 is a two-level press switch capable of detecting a half-pressed state (state S1) and a depressed state (state S2) by the user (operator). In the half-pressed state, preparation for image capturing (hereinafter, referred to as “image capturing preparation”) such as automatic focus control (AF), automatic exposure control (AE), and automatic white balance control (AWB) starts. In the depressed state, the image capturing operation for capturing an image to be recorded (captured image) starts.

The rear LCD 5 performs preview display (also referred to as “live view display”) prior to the image capturing, quick view display (also referred to as “after view display”) for making the user check a captured image immediately after the image capturing, and playback display of a captured image stored in the memory card 90. The rear LCD 5 has the predetermined number (in this case, 640×480) pixels and can display a high-definition color image.

The rear LCD 5 functions as means for displaying a screen (guide screen) for guiding the user to the destination while showing a present place, destination, and the like on a map in a car navigation system 100 (FIG. 5) which will be described later. This point will be described in detail later.

The user can perceive the position, size, and the like of a subject in an image by checking the live view display on the rear LCD 5 and perform framing operation.

The quick review button QB has the function of switching between an image capturing mode (camera mode) and a playback mode. Concretely, as a rule, each time the quick review button QB is depressed, the two modes are sequentially and cyclically selected.

The cross key CS can move various cursors on a screen displayed on the rear LCD 5 in four ways of up, down, right, and left. For example, when the execution button EX is depressed in a state where a cursor is positioned on a desired option by using the cross key CS, setting operation or the like corresponding to the option is executed.

The microphone 12 is used for obtaining (recording) voice data to be recorded in a voice guide generating mode which will be described later. The recording operation starts when the recording button RB is depressed and finishes when the recording button RB is depressed again.

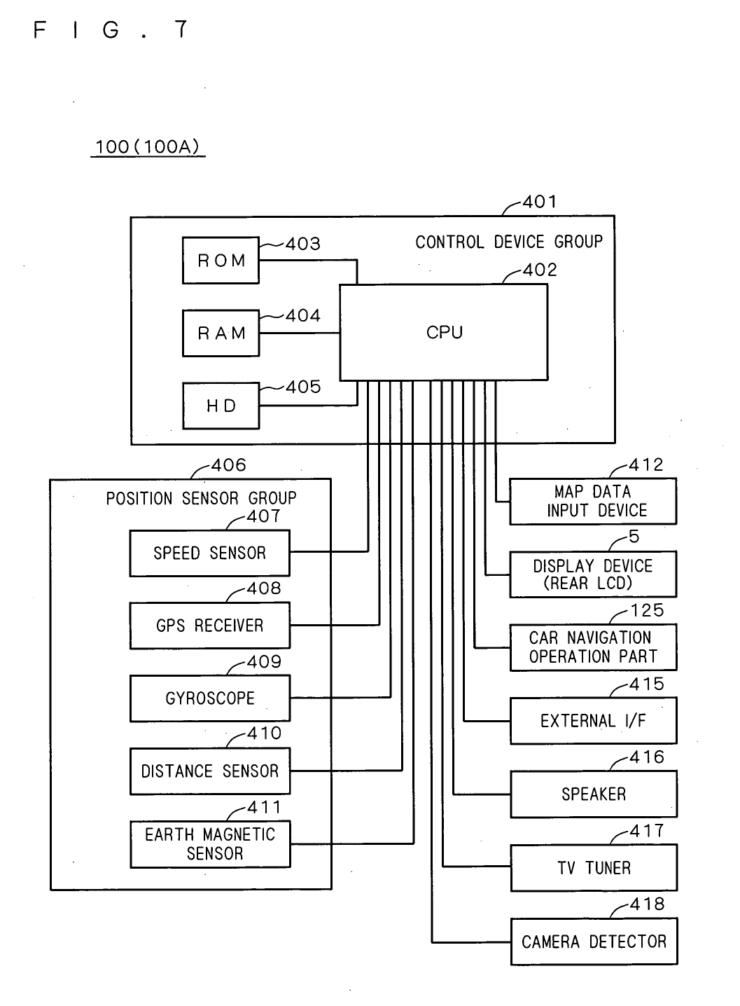

Referring now to FIG. 4, the internal configuration of the image capturing apparatus 1 will be described. FIG. 4 is a block diagram showing the internal functions of the image capturing apparatus 1.

An image capturing part 308 has a CCD (image capturing device) and photoelectrically converts a subject image based on light from a subject incident from the taking lens 2, thereby obtaining an electric image signal (captured image) of the subject. The image signal is properly subjected to an analog signal process by an image processor 307 and converted to a digital image signal. The digital image signal is input to a computing processor (CPU) 304. In the CPU 304, processes such as black level correction, white balance correction, and y correction are performed on a digital image signal.

The CPU 304 reads a control program, and parameters necessary for various controls, various settings, and the like stored in a program part 309, and executes the control program, thereby realizing the control on the whole image capturing apparatus 1, various functions, and the like. A program line and the like used for exposure control are stored in the program part 309.

The CPU 304 temporarily stores the image data subjected to the various image processes into an image memory 306. At the time of image capturing, the image data (captured image) temporarily stored in the image memory 306 is sent to a memory card slot in which the memory card 90 is inserted at a predetermined timing, thereby storing the image data onto the memory card 90.

The rear LCD 5 displays a live view and a playback image of a captured image stored in the memory card 90. For example, at a timing a live view before image capturing is displayed, image data temporarily stored on the image memory 306 is transmitted to the rear LCD 5 at a predetermined timing while the CPU 304 converts the resolution in accordance with the pixel size of the rear LCD 5, thereby displaying the live view on the rear LCD 5.

An operation part 302 includes the power switch 3, release button 9, cross key CS, execution button EX, quick review button QB, and recording button RB. In response to an operation on the operation part 302 by the user, various signals are output from the operation part 302 to the CPU 304 and are processed by the CPU 304. In such a manner, the operation of the image capturing apparatus 1 in accordance with the operation of the user is realized.

An external interface (I/F) 303 has a connection part CP and a connection terminal (not shown) for connecting to an external device such as a personal computer, a television, and a printer via a cable so as to be able to transmit/receive data. The connection part CP is used to connect the image capturing apparatus 1 to the car navigation system body 110 which will be described later so as to able to receive data from the navigation system body (connection state). Data transmission/reception by the connection part CP will be described later.

The microphone 12, receives voice generated by the user, converts the voice into voice data, and outputs the voice data to the CPU 304. The voice data is properly added to a captured image and stored into the memory card 90 or the like.

The power source battery BT is a secondary battery which is repeatedly used by charging and discharging as the power source of the image capturing apparatus 1. In this case, the power source battery (hereinafter, also referred to as “accumulator”) BT can be charged by accumulating power supplied from the car navigation system body 110 (FIG. 5) which will be described later via the connection part CP.

Car Navigation System

FIG. 5 is a diagram showing an example of the configuration of a car navigation system 100 according to the preferred embodiment of the present invention.

The car navigation system 100 is constructed by the car navigation system body 110, a connection fixing stand 120, a connection cable 130, and the image capturing apparatus 1. In the car navigation system 100, the image capturing apparatus 1 is connected to the connection fixing stand 120 via the connection part CP so as to be able to transmit/receive data.

The car navigation system body 110 has various controllers, detectors, and the like of the car navigation system 100. Main components are disposed, for example, under the seat of a car.

The connection fixing stand 120 is connected to the car navigation system body 110 via the connection cable 130 so as to be able to transmit/receive data to connect the image capturing apparatus 1 to the car navigation system body and fix the image capturing apparatus 1. On the connection fixing stand 120, an operation part (car navigation operation part) used by the user to perform various operations on the car navigation system 100 is disposed.

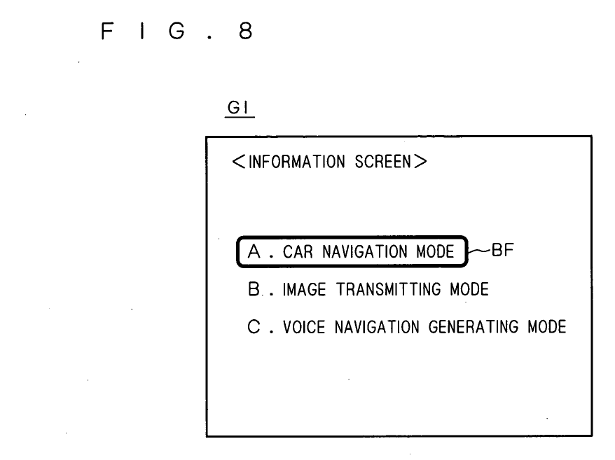

FIG. 6 is a front view showing an external configuration of the connection fixing stand 120 and the image capturing apparatus 1 in the car navigation system 100.

The connection fixing stand 120 has a car navigation operation part 125 and has an L shape. A groove (not shown) in which the image capturing apparatus 1 is to be fit is formed in the connection fixing stand 120. While making the image capturing apparatus 1 fit in the groove in the connection fixing stand 120, the connection part CP of the image capturing apparatus 1 is mechanically connected to a connection terminal unit 124 of the connection fixing stand 120, thereby enabling the image capturing apparatus 1 to be fixed to the connection fixing stand 120 as shown in FIG. 6.

By obtaining the state (connection state) where the image capturing apparatus 1 is connected to the car navigation system body 110 so as to be able to transmit/receive data as described above, the car navigation system 100 is formed. In the connection state, the rear LCD 5 of the image capturing apparatus 1 functions as a display of the car navigation system 100, which displays various guidance screens. In the following, when the rear LCD 5 functions as the display of the car navigation system 100, it will be called “display 5”.

That is, the connection fixing stand 120 plays the role of a stand (so-called cradle) connecting the image capturing apparatus 1 to the car navigation system body 110 so as to be able to send/receive data. In the connection state where the image capturing apparatus 1 is mechanically connected to the connection fixing stand 120 so as to be able to send/receive data, power is supplied from the car navigation system body 110 to the image capturing apparatus 1 via the connection cable 130, connection part CP, and the like. The power is received by the connection part CP and accumulated in the battery BT, thereby enabling the image capturing apparatus 1 to be charged.

With such a configuration, charging can be performed easily. Also in the case where the image capturing apparatus 1 is applied to the car navigation system 100, the image capturing apparatus 1 can be charged so that charging can be performed efficiently from the viewpoint of time.

When the user depresses a connection cancel button EB in the connection fixing stand 120 in a state where the image capturing apparatus 1 is fixed to the connection fixing stand 120 as shown in FIG. 6, the mechanical connection of the connection part CP of the image capturing apparatus 1 to the connection terminal unit 124 can be canceled. That is, the image capturing apparatus 1 can be attached/detached to/from the connection fixing stand 120. In a state where the image capturing apparatus 1 is attached to the connection fixing stand 120, the rear LCD 5 of the image capturing apparatus 1 functions as the display of the car navigation system 100. On the other hand, in a state where the image capturing apparatus 1 is detached (separated) from the connection fixing stand 120, the image capturing apparatus 1 functions as a normal image capturing apparatus which can be easily carried by the user.

In the car navigation system 100, by properly operating the car navigation operation part 125 or the rear operation part MB of the image capturing apparatus 1, the display mode of the screen on the display 5 can be changed.

Moreover, a storage medium 128 can be freely loaded/unloaded to/from the connection fixing stand 120.

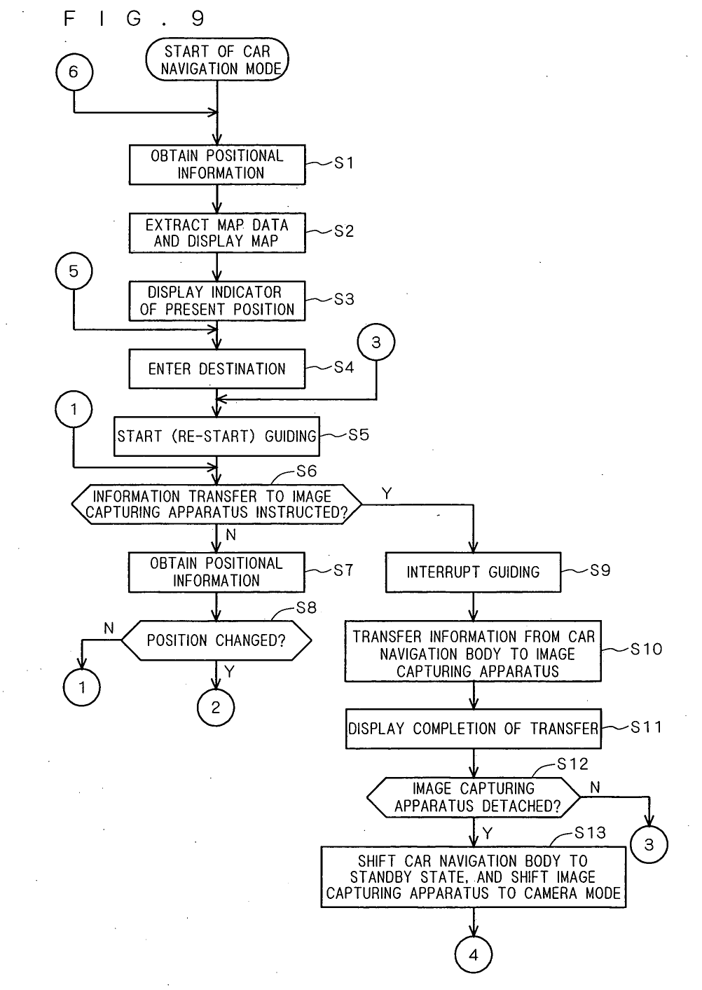

FIG. 7 is a block diagram showing the functional configuration of the car navigation system 100.

The functional configuration of the car navigation system 100 is roughly divided into three blocks: a controller device group 401, a position sensor group 406, and a device group for inputting/outputting other information.

The controller device group 401 has, mainly, a CPU 402, a ROM 403, a RAM404, and a hard disk (HD) 405. The controller group 401 realizes various controls by reading and executing various programs stored in the ROM 403 or HD 405 by the CPU 402. The control on the whole car navigation system 100 is executed by the functions of the CPU 402 and information obtained by the components of the car navigation system 100 is supplied to the CPU 402 and processed.

In the HD 405, data of latest maps (map database) is stored.

The position sensor group 406 has a speed sensor 407, a GPS receiver 408, a gyroscope 409, a distance sensor 410, and an earth magnetic sensor 411, and detects information (positional information) on the position of a vehicle on which the car navigation system 100 is mounted. The positional information obtained by the position sensor group 406 is output to the CPU 402.

The other device group includes a map data input device 412, the display (rear LCD) 5, a car navigation operation part 215, an external interface (I/F) 415, a speaker 416, a television tuner 417, and a camera detector 418.

The map data input device 412 is, for example, a DVD drive which accepts a storage medium and transmits information of the latest map stored on a DVD or the like to the HD 405 to update the map database.

The display 5 visibly displays various information such as a guidance screen in the car navigation system 100 as described above.

The car navigation operation part 125 is provided in the front face of the connection fixing stand 120 and outputs a signal according to an instruction of the user, that is, an operation on the car navigation operation part 125 to the CPU 402.

The external I/F 415 is provided for connection to, for example, a communication line such as an Internet line so as to be able to transmit/receive data or a power source for supplying power to the car navigation system 100.

The speaker 416 outputs a voice guidance or the like of the car navigation system 100, and the television tuner 417 displays a screen of normal television broadcast on the display 5.

The camera detector 418 detects whether the image capturing apparatus 1 is connected and fixed to the connection fixing stand 120 or not. For example, by detecting a mechanical force with a sensor, whether the image capturing apparatus 1 is connected and fixed to the connection fixing stand 120 or not can be detected.

Operation of Car Navigation System

The operation of the car navigation system 100 will now be described.

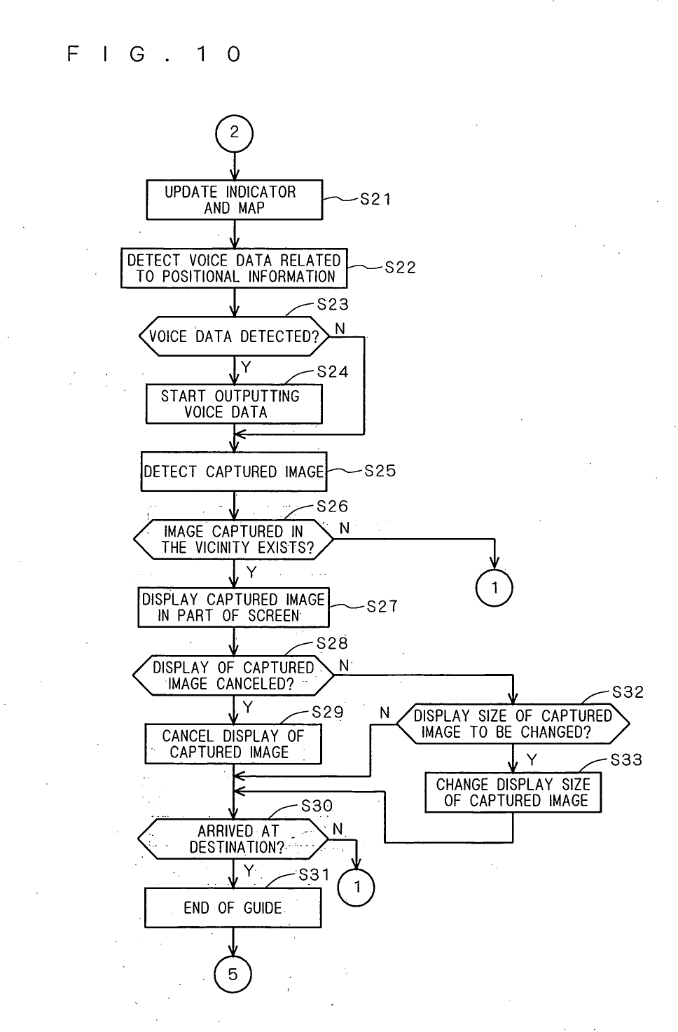

When the power switch included in the car navigation operation part 125 is depressed, a start screen of the car navigation system 100 is displayed and, after that, an information screen GI (FIG. 8) by which the user selects a function to be executed is displayed on the display 5.

On the information screen GI, three candidate items to be selected such as “car navigation mode”, “image transmitting mode”, and “voice navigation generating mode” are displayed in order from the top. By properly depressing an up or down button in a cross key included in the car navigation operation part 125, the user can put a thick-frame cursor (box frame) BF on one of the three items to be selected. When the user depresses an execution button included in the car navigation operation part 215 in the state where the box frame BF is put on the desired item, the desired item is selected and the function according to the desired item can be executed.

Operations in the modes will be described below.

Car Navigation Mode

FIGS. 9 to 11 are flowcharts showing the operation flow in a mode of guiding a car to a destination by outputting various information such as maps and voice (car navigation mode). The operation flow is realized when the CPU 402 executes the control program.

When the car navigation mode is selected on the information screen GI shown in FIG. 8, the operation of the car navigation mode of guiding the car to a destination starts and the program advances to step S1 in FIG. 9.

In step S1, the positional information is obtained by the position sensor group 406. In this case, positional information including latitudes, longitudes, and place names is obtained by the position sensor group 406.

In step S2, map data of one frame based on mainly the positional information obtained in step S1 is extracted from the map database stored in the HD 405 and a map is displayed on the display 5.

In step S3, a sign (indicator) indicative of the present position of the car is superimposed on the map displayed on the display 5.

In step S4, a screen for designating a destination is displayed and the user enters a destination. After that, the program advances to step S5.

In step S5, an operation of guiding the car (guiding operation) to the destination designated in step S4 while updating the screen (guidance screen) in which the indicator indicative of the present position of the car is superimposed on the map in accordance with changes in the car position starts.

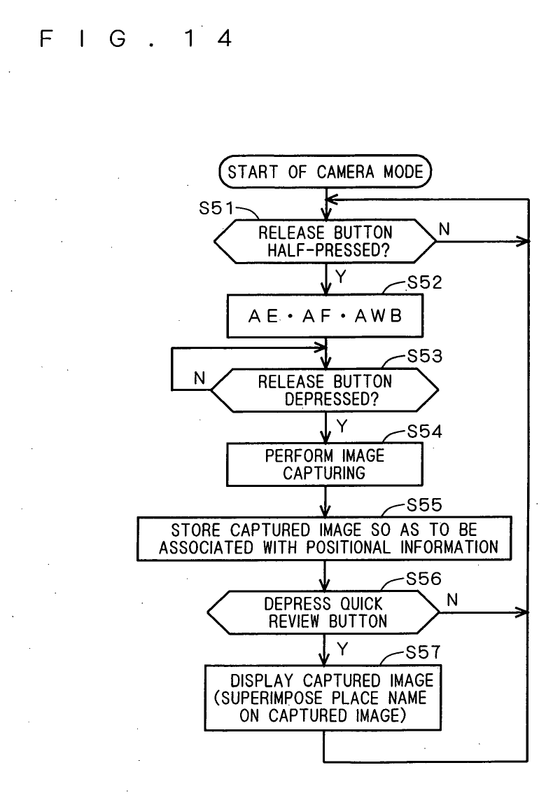

FIG. 12 is a diagram illustrating a guidance screen NG. As shown in FIG. 12, on the guidance screen, the destination (in this case, “xxx river”) is displayed in a right upper part. A square mark DP is superimposed in the position of the destination on the map, and an indicator CP1 indicative of the car position is also superimposed. The direction of the apex angle of the isosceles triangle of the indicator CP1 corresponds to the travel direction.

In step S6, whether an operation of the user (a predetermined operation on the car navigation operation part 125) instructing transfer of the positional information and the map data to the image capturing apparatus 1 is performed or not is determined. In the case where an instruction of transferring information and data to the image capturing apparatus 1 (information transfer instruction) is given, the program advances to step S9. In the case where there is no information transfer instruction, the program advances to step S7.

In step S7, in a manner similar to step S1, the positional information is obtained by the position sensor group 406.

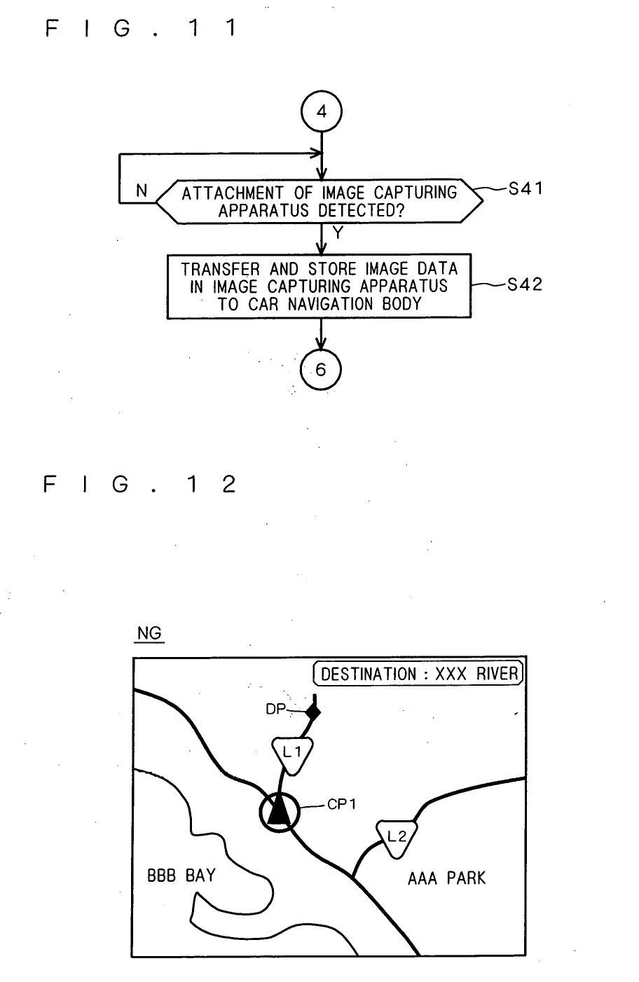

In step S8, by comparing the latest positional information obtained in step S7 with the positional information obtained last time, whether the car position has changed or not is determined. When the car position has changed, the program advances to step S21 in FIG. 10. When the car position has not changed, the program returns to step S6.

In step S9, the guiding operation is interrupted.

In step S10, the latest positional information and map data is transferred from the car navigation system body 110 (concretely, the CPU 402) to the image capturing apparatus 1. The image capturing apparatus 1 receives the positional information and map data from the CPU 304 and stores it into the memory card 90 or the like. The map data is formed as an image file and stored in the memory card 90.

In step S11, after completion of the transfer of the positional information and map data from the car navigation system body 110 to the image capturing apparatus 1, a screen notifying of the completion is displayed on the display 5.

In step S12, whether the image capturing apparatus 1 has been detached from the connection fixing stand 120 or not is determined. When the image capturing apparatus 1 is detached, the program is advanced to step S13. When the image capturing apparatus 1 is not detached, the program returns to step S5. Information of whether the image capturing apparatus 1 is detached or not is obtained from the camera detector 418.

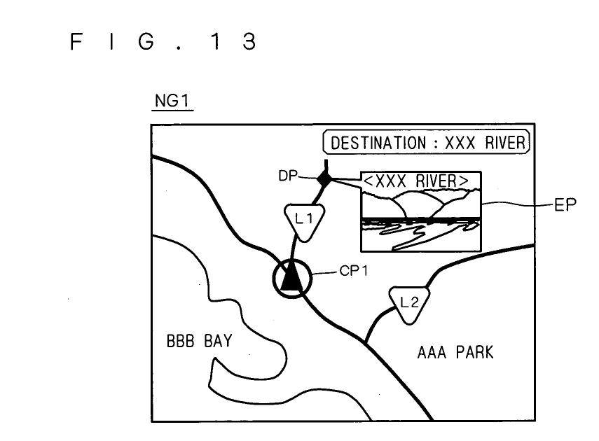

In step S13, the car navigation system body 110 shifts to a state (standby state) where it waits for attachment of the image capturing apparatus 1 to the connection fixing stand 120 while interrupting the guiding operation. In step S13, the image capturing apparatus 1 also shifts to a state (camera mode) where it can be used by itself as a portable image capturing apparatus. The program advances from step S13 to step S41 in FIG. 11.

In such a manner, the image capturing apparatus 1 can be taken out from the car navigation system 100. When the connection state in which the image capturing apparatus 1 and the car navigation system body 110 are connected to each other so as to be able to transmit/receive data is cancelled, the CPU 304 obtains the positional information from the car navigation system body 110 and stores it in the memory card 90.

First, the case where the program advances from step S8 to step S21 in FIG. 10 will be described.

In step S21, the indicator of the car position and display of the map are updated according to the positional information obtained in step S7.

In step S22, voice data related to the positional information obtained in step S7 is detected from voice data stored in the HD 405. The voice data includes announcement voice of place names and the names of intersections, and data of voice recorded in a voice navigation generating mode which will be described later.

In step S23, on the basis of the detection result of step S22, whether voice data related to the positional information exists in the HD 405 or not is determined. If YES, the program advances to step S24. If NO, the program advances to step S25.

In step S24, operation of outputting voice based on the voice data detected in step S22 from the speaker 416 is started.

In step S25, a captured image related to a position in the vicinity of the car position is detected from data stored in the HD 405. The captured image includes a captured image obtained in a camera mode which will be described later and stored in the HD 405 in a state where it is associated with the positional information obtained by the position sensor group 406 (also referred to as “captured image with positional information”). When one or more captured images exist in the HD 405, the CPU 402 can easily identify the place where the captured image was obtained by referring to the positional information associated with the captured image. Operation of storing the captured image with the positional information in the HD 405, and the like will be described later.

In step S26, whether a captured image related to a position in the vicinity of the car position exists in the HD 405 or not is determined on the basis of the detection result of step S25. If YES, the program advances to step S27. If NO, the program returns to step S6 in FIG. 9.

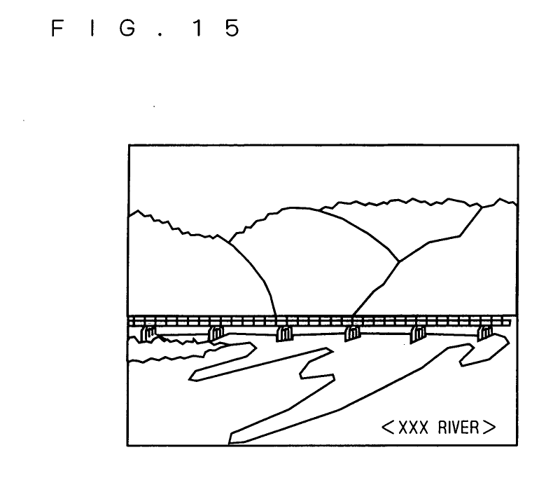

In step S27, the captured image detected in step S25 is displayed in part of the guidance screen. FIG. 13 is a diagram illustrating a guidance screen NG1 in part of which the captured image is displayed. For example, in the case where a captured image of the xxx river as the destination, which exists near the car position is stored in the HD 405, a balloon display EP including the captured image of the xxx river appears from the mark DP indicative of the destination on the guide screen. The captured image included in the balloon display EP is displayed with the place name included in the positional information associated with the captured image.

In such a manner, the captured image with the positional information is displayed on the display 5 in accordance with the positional information obtained by the position sensor group 406, so that original image information can be added to prepared guidance information. As a result, information in the car navigation system 100 can be enriched. Concretely, by displaying the captured image of the destination, the user can grasp whether the destination matches the place of the captured image or not. By also displaying captured images of places other than the destination, the user can easily grasp a place he/she has visited and how the place looks.

Since the place name is added to the capture image included in the balloon display EP, the user can indirectly refer to positional information associated with the captured image by referring to the added place name. As a result, the place where the captured image was captured can be easily identified.

In step S28, whether display of the captured image superimposed on the guidance screen is canceled or not is determined. In the case where an instruction of canceling display of the captured image superimposed on the guidance screen is given by an operation on the car navigation operation part 125 by the user, the program advances to step S29. When an instruction of canceling display of the captured image is not given, the program advances to step S32.

In step S29, display of the captured image superimposed on the guidance screen is cancelled. Specifically, the screen displayed on the display 5 is changed, for example, from the screen as shown in FIG. 13 to the screen as shown in FIG. 12.

In step S30, whether the car has arrived the destination or not is determined. By comparing positional information of the present car position with the positional information of the destination, whether the car has arrived the destination or not can be determined. If YES, the program advances to step S31. If NO, the program returns to step S6 in FIG. 9.

In step S31, the guiding operation is finished, and the program returns to step S4 in FIG. 9. That is, by changing the destination, a new guiding operation can be started.

In step S32, whether the display size of the captured image displayed on the guidance screen is changed or not is determined. The display size of the captured image can be changed by an operation on the car navigation operation part 125 of the user. If an instruction of changing the display size of the captured image (size change instruction) is given by the user, the program advances to step S33. If the size change instruction is not given, the program advances to step S30.

In step S33, the display size of the captured image is changed. In the preferred embodiment, the size of the captured image displayed in part of the guidance screen can be changed in two levels. In the case where the display size of the captured image is originally relatively small, it is changed to relatively large size. On the contrary, when the display size of the captured image is originally relatively large, it is changed to relatively small size.

After that, the program advances from step S33 to step S30.

Next, the case where the program advances from step S113 in FIG. 9 to step S41 in FIG. 11 will be described.

In step S41, whether attachment of the image capturing apparatus 1 is detected by the camera detector 418 or not is determined. The process of step S41 is repeated until attachment of the image capturing apparatus 1 is detected and, when attachment is detected, the program advances to step S42. Specifically, until the image capturing apparatus 1 is fixedly connected to the connection fixing stand 120 and is attached, the car navigation system body 110 is held in the standby state.

In step S42, image data (captured image) stored in the memory card 90 in the image capturing apparatus 1 is transferred to the car navigation system body 110 via the connection part CP, and stored in the HD 405. At this time, the captured image transferred from the car navigation system body 110 to the image capturing apparatus 1 in step S10 and associated with the positional information stored in the memory card 90 (captured image with positional information) is stored in the HD 405. After completion of the process in step S42, the program returns to step S1 in FIG. 9.

The operation flow in the car navigation mode in the car navigation system 100 has been described above. Alternatively, the operation of the car navigation mode can be forcedly finished by proper operation of the user on the car navigation operation part 125, and the information screen GI (FIG. 8) may be displayed on the display 5.

FIG. 14 shows an operation flow of the image capturing apparatus 1 in the case where the image capturing apparatus 1 can be used by itself as a portable image capturing apparatus and is set in the camera mode of performing image capturing. The operation flow is realized when the CPU 304 executes a control program.

When the power source of the image capturing apparatus 1 is turned on and is set in the camera mode, a live view is displayed on the rear LCD 5. The program advances to step S51 in FIG. 14. Also in the case where the image capturing apparatus 1 is set in the camera mode in step S13 in FIG. 9, the program similarly advances to step S51 in FIG. 14.

In step S51, whether the release button 9 is half-depressed or not is determined. In this case, the process of step S51 is repeated until the release button 9 is half-pressed. When the release button 9 is half-pressed, the program advances to step S52.

In step S52, preparation for image capturing of AF, AE, AWB, and the like is made.

In step S53, whether the release button 9 is depressed or not is determined. Until the release button 9 is depressed, the process of step S53 is repeated. When the release button 9 is depressed, the program advances to step S54. Although not shown, the process of step S53 is repeated for a predetermined period (for example, two seconds) or longer, the program returns to step S51.

In step S54, the image capturing operation is executed.

In step S55, the captured image obtained in step S54 is associated with the positional information stored in the memory card 90 in step S10 in FIG. 9, and the resultant is stored in the memory card 90. For example, by making the positional information included in tag information of a file storing captured image data, the captured image and the positional information can be stored so as to be associated with each other. In such a manner, in the camera mode, the captured image is stored in the memory card so as to be associated with the positional information obtained from the car navigation system body 110.

In step S56, whether the quick review button QB is depressed or not is determined only for a predetermined period (for example, three seconds). When the quick review button QB is depressed, the program advances to step S57. If the quick review button QB is not depressed, the program returns to step S51. Although not shown, in step S56, a live view is displayed on the rear LCD 5. When the release button 9 is half-pressed in this state, the program forcedly returns to step S51.

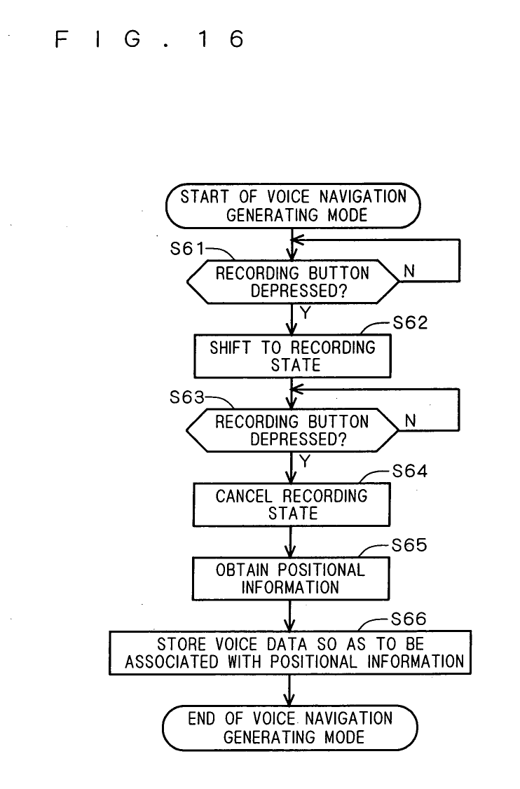

In step S57, the captured image stored in the memory card 90 in step S55 is reproduced and displayed on the rear LCD 5 for a predetermined period (for example, five seconds). At this time, as shown in FIG. 15, the place name included in the positional information is superimposed on a captured image. The user sees the superimposed place name and can refer to the positional information associated with the captured image, so that the place where the image was captured can be easily identified.

Although not shown, when the release button 9 is half-pressed in step S57, the program forcedly returns to step S51.

When the power source of the image capturing apparatus 1 is turned on and a playback mode is set, a captured image stored in the memory card 90 most recently is displayed on the rear LCD 5. By properly depressing the right or left button of the cross key CS in this state, the image stored in the memory card 90 can be reproduced and displayed on the rear LCD 5. At this time, map data stored in the memory card 90 in step S110 in FIG. 9 can be output so as to be displayed on the rear LCD 5 as shown in FIG. 15. With such a configuration, the user can take the image capturing apparatus 1 from the car navigation system 100, carry it, and walk while watching the map of the area. The user consequently does not get lost in a town or the like.

Voice Navigation Generating Mode

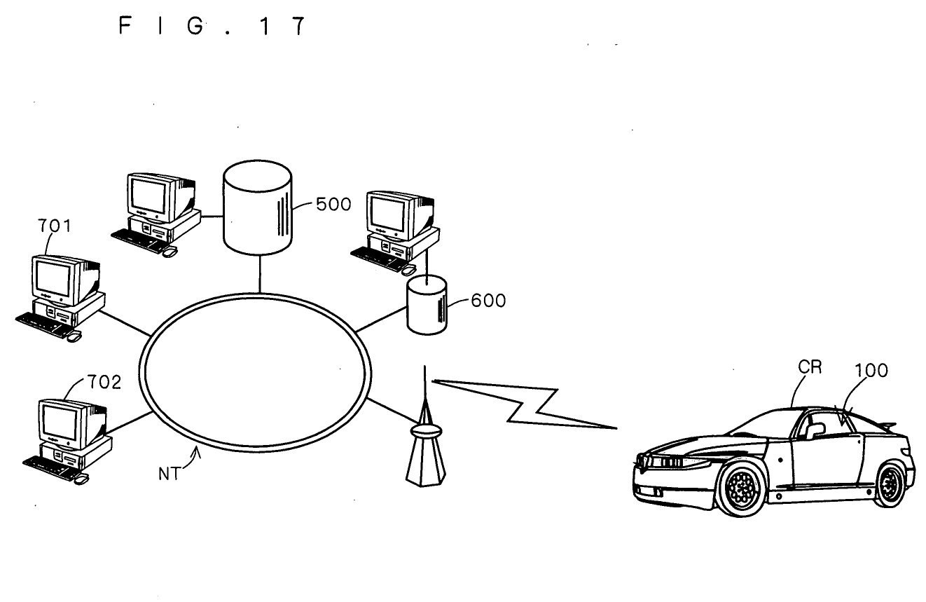

FIG. 16 is a flowchart showing an operation flow of a mode for adding guidance by using the user's voice to the guiding operation (voice navigation generating mode). The operation flow is realized when the CPU 402 executes a control program.

When the voice navigation generating mode is selected on the information screen GI shown in FIG. 8, the operation of the voice navigation generating mode starts, and the program advances to step S61 in FIG. 16.

In step S61, whether the recording button RB is depressed or not is determined. In this case, the process of step S61 is repeated until the recording button RB is depressed. When the recording button RB is depressed, the program advances to step S62.

In step S62, the program shifts to a state (recording state) where recording operation of receiving voice generated by the user by the microphone 12, generating voice data based on the voice, and temporarily storing the voice data into the RAM of the CPU 304 is executed.

In step S63, whether the recording button RB is depressed or not is determined. The process of step S63 is repeated until the recording button RB is depressed and, when the recording button RB is depressed, the program advances to step S64.

In step S64, the recording state is canceled. The recording state is maintained until the recording button RB is depressed again.

In step S65, positional information is obtained by the position sensor group 406.

In step S66, the positional information obtained in step S65 and voice data temporarily stored in the RAM in steps S62 to S64 is associated with each other and stored in the HD 405. After that, the operation of the voice navigation generating mode is finished. Association between the voice data and the positional information can be realized by, for example, adding the positional information to tag information of a file storing voice data.

By the operation as described above, voice data related to the positional information to be detected in step S22 in FIG. 10 can be generated. Therefore, original voice information such as information based on the experience of the user (for example, information of a side road, a shop, and the like) can be added to prepared guide information. Thus, the information in the navigation system can be enriched.

Image Transmitting Mode

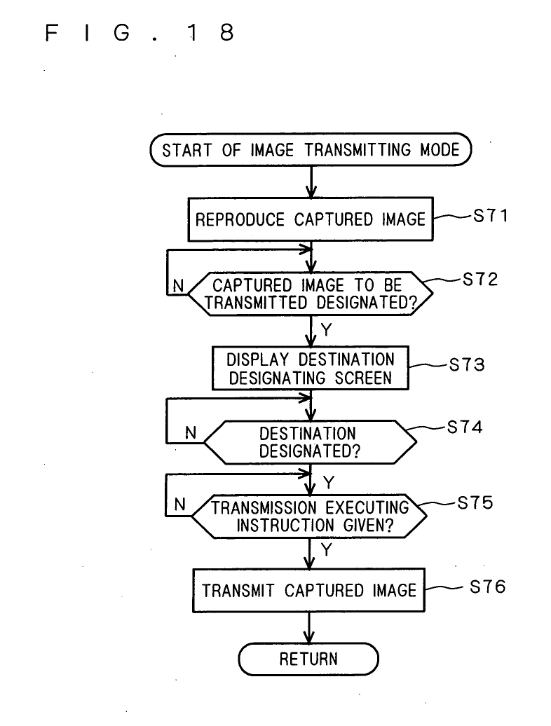

FIG. 17 is a diagram for explaining the communication function of the car navigation system 100 set in an image transmitting mode.

As shown in FIG. 17, the car navigation system 100 is mounted on a car CR and is connected to a network line NT so as to be able to transmit/receive data by radio communication. A plurality of terminal devices (such as personal computers) 701 and 702, various servers 500 and 600, and the like are connected to the network line NT so as to be able to send/receive data. Therefore, data can be transmitted/received among the car navigation system 100, plural terminal devices 701 and 702, various servers 500 and 600, and the like.

FIG. 18 is a flowchart showing the operation flow of a mode (image transmitting mode) of transmitting an image captured in the image capturing operation in the image capturing apparatus 1 to an external device by using the communication function of the car navigation system 100. The operation flow is realized when the CPU 402 executes the control program.

When the image transmitting mode is selected on the information screen GI shown in FIG. 8, the operation of the image transmitting mode is started and the program advances to step S71 in FIG. 18.

In step S71, the captured image stored in the HD 405 is reproduced and a screen for designating a captured image to be transmitted (transmission image designating screen) is displayed.

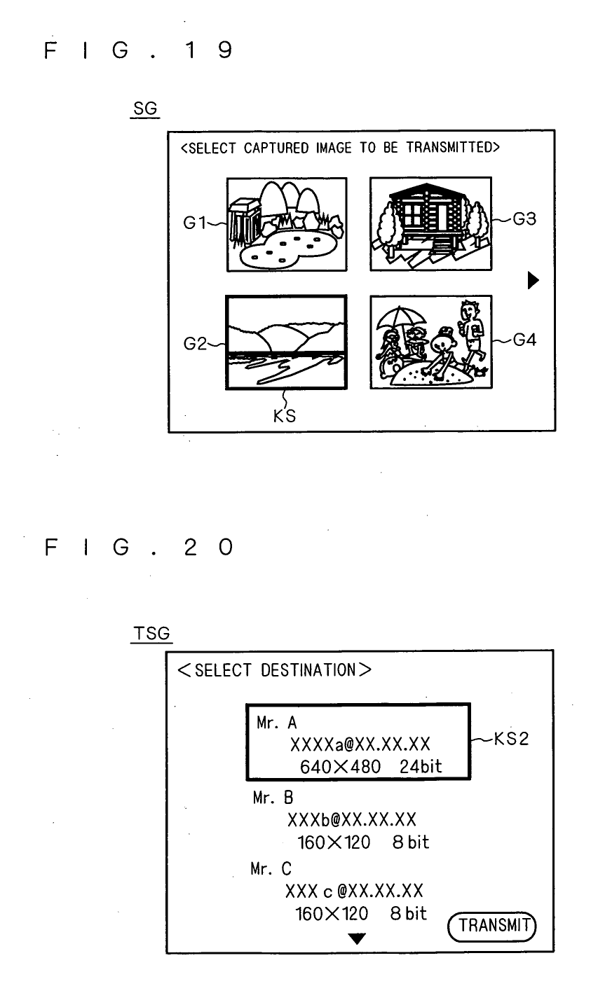

FIG. 19 is a diagram illustrating a transmission image designating screen SG. In the transmission image designating screen SG, one or more (in this case, four) captured images G1 to G4 stored in the HD 405 are arranged and displayed. A captured image to be displayed can be sequentially changed by depressing the right or left button in the cross key CS. In the transmission image designating screen SG, by putting a thick-line frame cursor (box frame) KS on an image to be transmitted among the plurality of captured images G1 to G4 and depressing the execution button EX, the captured image to be transmitted can be designated.

In step S72, whether the captured image to be transmitted is designated or not is determined. In this case, the determination in step S72 is repeated until the captured image to be transmitted is designated on the transmission image designating screen. When the captured image to be transmitted is designated, the program advances to step S73.

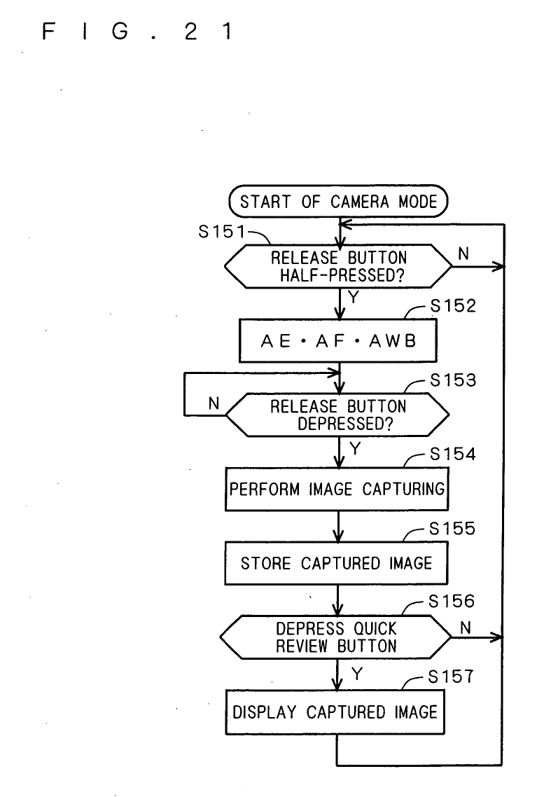

In step S73, a screen for designating the destination of the captured image (destination designating screen) is displayed. FIG. 20 is a diagram illustrating a destination designating screen TSG. In the destination designating screen TSG, names as candidates of the destination are displayed in order from top on the basis of address information pre-stored in the HD 405. Below the right part of each name, corresponding mail address, size of an image to be transmitted, and gradation level are displayed. In the destination designating screen TSG shown in FIG. 20, three candidates are simultaneously displayed in the vertical direction. By putting a thick-line frame cursor (box frame) KS2 on a desired address and depressing the execution button EX, the desired address (that is, destination) can be designated.

In step S74, whether the destination of a captured image is designated or not is determined. In the destination designating screen, determination of step S74 is repeated until the destination is designated. When the destination is designated, the program advances to step S75.

In step S75, whether there is an instruction of executing transmission (transmission executing instruction) or not is determined. Until the user properly operates the car navigation operation part 125 to give a transmission executing instruction, the determination of step S75 is repeated. After the transmission executing instruction is given, the program advances to step S76.

In step S76, operation of transmitting the captured image designated in the transmission image designating screen to the destination designated in the destination designating screen is executed. The program returns to step S71. At this time, the size and gradation of the captured image to be transmitted are adjusted to those of an image corresponding to the destination and then transmission is executed.

In such a manner, an image captured by the image capturing apparatus 1, transferred to the car navigation system body 110, and stored in the HD 405 is transmitted to various external devices via the network line NT.

When a captured image is transmitted in a file in which position information is included in tag information, by referring to the tag information in the file at the destination, the place where the transmitted captured image is captured can be easily identified.

The user can forcedly finish the operation flow in the image transmitting mode by properly operating the car navigation operation part 125 or the like.

As described above in the car navigation system 100 according to the preferred embodiment of the present invention, as means for displaying a guidance screen of the navigation system, the rear LCD 5 provided for the image capturing apparatus 1 which can be carried by the user and capable of displaying a high-definition image is used. That is, the chassis in which the display of the car navigation system 100 is formed is separated and can be used as a digital camera. With the configuration, without providing the image capturing apparatus 1 with most of the functions necessary for car navigation, only by connecting the image capturing apparatus 1 to the car navigation system body 110 so as to be able to transmit/receive data, the car navigation system 100 is formed. Therefore, the present invention can provide the portable image capturing apparatus 1 having the navigation function while preventing increase in the size and manufacturing cost of the apparatus by not providing the image capturing apparatus 1 with too many functions.

When the state where the image capturing apparatus 1 is connected to the car navigation system body 110 so as to be able to receive data is canceled, the positional information obtained from the car navigation system body 110 is stored in the memory card 90. The stored positional information is associated with the image captured by the image capturing apparatus 1 and stored into the memory card 90. With the configuration, at the time of performing image capturing around the place where the image capturing apparatus 1 is taken out from the car navigation system 100, the positional information corresponding to the image capturing place can be associated with the captured image.

According to the present positional information obtained by the position sensor group 406 of the car navigation system body 110, the captured image with positional information is displayed. With such a configuration, original image information which is obtained in a real-time manner can be added to prepared guidance information. Thus, information in the car navigation system 100 can be enriched.

The image captured by the image capturing apparatus 1 is transmitted to the external device via the communication line such as the network line NT by using the communication function of the car navigation system 100. With such a configuration, the captured image can be transmitted to various places by using existing functions of the car navigation. Therefore, while preventing increase in the size and cost of the apparatus, the functions of the communication tool are added, and convenience can be further improved.

The image capturing apparatus 1 obtains map data from the car navigation system body 110. When the image capturing apparatus 1 is taken out from the car navigation system 100, the map data preliminarily obtained is output visibly. With such a configuration, the user can take the image capturing apparatus 1 from the car navigation system 100, carry it, and walk while watching the map of the area. The user consequently does not get lost in a town or the like.

Voice of the user is received by the microphone 12 of the image capturing apparatus 1, and voice data is generated and stored as voice guide information associated with the positional information obtained by the car navigation system body 110 into the HD 405. With such a configuration, while utilizing the function of the microphone originally provided for the camera, by outputting the voice guide of words of the user himself/herself and actual images captured by the user himself/herself, an original friendly indicator can be added. Further, original voice information can be added to the prepared guide information, so that information in the car navigation system 100 can be enriched.

When the image capturing apparatus 1 is connected and fixed to the connection fixing stand 120 to form the car navigation system 100, the image capturing apparatus 1 receives supply of power from the car navigation system body 110 and accumulates it in the battery BT, thereby performing charging. With such a configuration, charging can be performed easily. Since the image capturing apparatus 1 can be charged also when applied to the car navigation system 100, charging which is efficient from the viewpoint of time can be realized.

Modifications

Although the preferred embodiment of the present invention has been described above, the present invention is not limited to the foregoing preferred embodiment.

For example, in the foregoing preferred embodiment, when the image capturing apparatus 1 is taken out from the car navigation system 100, positional information is stored in the memory card 90. However, the present invention is not limited to the preferred embodiment. Alternatively, for example, image capturing is performed by an image capturing apparatus 1A. After that, when the image capturing apparatus 1A is connected to a car navigation system body 110A so as to be able to transmit/receive data, a captured image transferred from the image capturing apparatus 1A to the car navigation system body 110A and positional information obtained by the position sensor group 406 may be associated with each other and stored in the HD 405. With such a configuration as well, at the time of capturing an image in an area where the image capturing apparatus 1A is taken out from a car navigation system 100A, the positional information corresponding to the image capturing place can be associated with the captured image.

The image capturing apparatus 1A, car navigation system body 110A, and car navigation system 100A according to the modification have controls different from the image capturing apparatus, 1, car navigation system body 110, and car navigation system 100 according to the preferred embodiment but have similar configuration. Consequently, only different controls will be described below.

The operation flow of the image capturing apparatus 1A and the car navigation system 100A in the case where the image capturing apparatus 1A and the car navigation system body 110A are connected to each other, position information is obtained and associated with a captured image, and the resultant is stored in the HD 405 will be described.

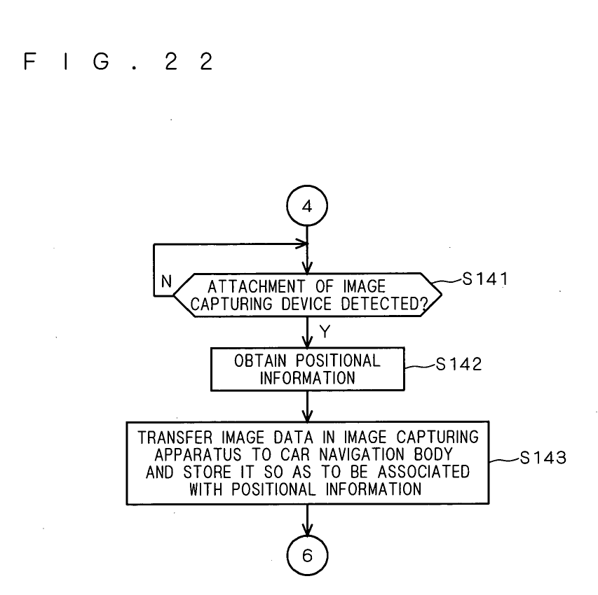

FIG. 21 shows an operation flow of the image capturing apparatus 1A in the case where the image capturing apparatus 1A according to the modification is set in the camera mode. The operation flow is realized when the CPU 304 executes the control program.

When the image capturing apparatus 1A is set in the camera mode by turn-on of the power or the like, a state in which a live view is displayed on the rear LCD 5 is obtained. The program advances to step S151 in FIG. 21.

In steps S151 to S154, processes similar to those of steps S51 to S54 in FIG. 14 are performed.

In step S155, an image captured in step S154 is stored into the memory card 90.

In step S156, in a manner similar to step S56 in FIG. 14, whether the quick review button QB is depressed or not is determined only for a predetermined period (for example, three seconds). When the quick review button QB is depressed, the program advances to step S157. When the quick review button QB is not depressed, the program returns to step S151. Although not shown, in step S156, a live view is displayed on the rear LCD 5. When the release button 9 is half-pressed, the program forcedly returns to step S151.

In step S157, a captured image stored in the memory card 90 in step S155 is reproduced and displayed on the rear LCD 5 for a predetermined period (for example, five seconds). Although not shown, in step S157, when the release button 9 is half-pressed, the program forcedly returns to step S151.

At this time, the operation flow of FIG. 11 is like that shown in FIG. 22. The operation flow of FIG. 22 will be described below.

In step S141, process similar to that in step S41 is performed.

In step S142, positional information is obtained by the position sensor group 406.

In step S143, image data (captured image) stored in the memory card 90 in the image capturing apparatus 1A is transferred to the car navigation system body 110A and stored in the HD 405. At this time, the positional information obtained in step S142 and the captured image transferred to the car navigation system body 110A are associated with each other and stored in the HD 405.

In the foregoing preferred embodiment, a captured image is automatically displayed small on the guide screen. However, the present invention is not limited to the preferred embodiment. For example, when the car arrives at the destination, the captured image may be displayed in the full screen of the display 5. By various operations of the user on the car navigation operation part 125 in such a display state, more detailed information (such as latitude, longitude, place name, and the like) may be visually output.

Although voice navigation is generated in a state where the image capturing apparatus 1 is connected to the car navigation system body 110 so as to be able to transmit/receive data in the foregoing preferred embodiment, the present invention is not limited to the preferred embodiment. For example, voice data may be generated on the basis of voice of the user when the image capturing apparatus is used by itself, and associated with positional information stored in the memory card 90.

Although the microphone is provided for the image capturing apparatus 1 in the foregoing preferred embodiment, the present invention is not limited to the configuration. The microphone may exist in either the image capturing apparatus 1 or the car navigation system body 110.

In the foregoing preferred embodiment, the car navigation system to be mounted on a vehicle such as a car has been described as an object. The present invention can be generally applied to systems (navigation systems) for guiding other various movable bodies or the like.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus which can be carried by a user, comprising:
an image capturing part for capturing an image of a subject;
an image storage part for storing a captured image which is captured by said image capturing part;
an image display part for displaying said captured image stored in said image storage part; and
a connection part for setting a connection state where said image capturing apparatus is connected to a predetermined navigation system body so as to be able to receive data from said predetermined navigation system body, wherein
in said connection state, said image display part functions as a guide screen display part for displaying a guide screen of a navigation system.

2. The image capturing apparatus according to claim 1, wherein
said image storage part stores said captured image so as to be associated with positional information obtained from said predetermined navigation system body.

3. The image capturing apparatus according to claim 2, further comprising:
a position information obtaining part for obtaining said positional information from said predetermined navigation system body when said connection state is canceled.

4. The image capturing apparatus according to claim 2, further comprising:
a data transmission part for transmitting said captured image stored in said image storage part to said predetermined navigation system body in said connection state, wherein
said captured image transmitted by said data transmission part is stored in a predetermined information storage part so as to be associated with said positional information in said predetermined navigation system body.

5. The image capturing apparatus according to claim 1, further comprising:
a data transmission part for transmitting said captured image stored in said image storage part to said predetermined navigation system body in said connection state, wherein
said captured image transmitted by said data transmission part is stored in a predetermined information storage part so as to be associated with positional information obtained by a predetermined positional information detection part in said predetermined navigation system body.

6. The image capturing apparatus according to claim 4, wherein
said guide screen display part visibly outputs a captured image corresponding to positional information obtained by a predetermined positional information detection part from one or more captured images stored in association with positional information in said predetermined information storage part.

7. The image capturing apparatus according to claim 1, further comprising:
a data transmission part for transmitting said captured image stored in said image storage part to said predetermined navigation system body in said connection state, wherein
said captured image transmitted by said data transmission part is transmitted to an external device via a predetermined communication line by a communication part of said predetermined navigation system body.

8. The image capturing apparatus according to claim 1, further comprising:
a map data reception part for receiving map data from said predetermined navigation system body in said connection state; and
a map data storage part for storing said map data received by said map data reception part, wherein
said image display part visibly outputs said map data stored in said map data storage part in a state where said connection state is canceled.

9. The image capturing apparatus according to claim 1, further comprising:
a voice data generation part for receiving voice generated by the user and generating voice data, wherein
in said connection state, voice data generated by said voice data generation part and positional information obtained by said predetermined navigation system body is associated with each other and the resultant information is stored as voice guide information in a predetermined voice guide information storage part.

10. The image capturing apparatus according to claim 1, further comprising:
a power reception part for receiving supply of power from said predetermined navigation system body in said connection state; and
an accumulation part for accumulating said power received by said power reception part, wherein
said accumulation part is included in a power source of said image capturing apparatus.

11. A navigation system comprising:
an image capturing apparatus which can be carried by a user; and
a predetermined navigation system body, wherein
said image capturing apparatus includes:
an image capturing part for capturing an image of a subject;
an image storage part for storing a captured image which is captured by said image capturing part;
an image display part for displaying said captured image stored in said image storage part; and
a connection part for setting a connection state where said image capturing apparatus is connected to said predetermined navigation system body so as to be able to receive data from said predetermined navigation system body, and
in said connection state, said image display part functions as a guide screen display part for displaying a guide screen of said navigation system.

12. The navigation system according to claim 11, wherein
said image storage part stores said captured image so as to be associated with positional information obtained from said predetermined navigation system body.

13. The navigation system according to claim 12, wherein
said image capturing apparatus further includes:
a positional information obtaining part which obtains said positional information from said predetermined navigation system body when said connection state is canceled.

14. The navigation system according to claim 12, wherein
said image capturing apparatus further includes:
a data transmission part for transmitting said captured image stored in said image storage part to said predetermined navigation system body in said connection state, and
said captured image transmitted by said data transmission part is stored in a predetermined information storage part so as to be associated with said positional information in said predetermined navigation system body.

15. The navigation system according to claim 11, wherein
said image capturing apparatus further includes:
a data transmission part for transmitting said captured image stored in said image storage part to said predetermined navigation system body in said connection state, and
said captured image transmitted by said data transmission part is stored in a predetermined information storage part so as to be associated with positional information obtained by a predetermined positional information detection part in said predetermined navigation system body.

16. The navigation system according to claim 14, wherein
said guide screen display part visibly outputs a captured image corresponding to positional information obtained by a predetermined positional information detection part from one or more captured images stored in association with positional information in said predetermined information storage part.

17. The navigation system according to claim 11, wherein
said image capturing apparatus further includes:
a data transmission part for transmitting said captured image stored in said image storage part to said predetermined navigation system body in said connection state, and
said captured image transmitted by said data transmission part is transmitted to an external device via a predetermined communication line by a communication part of said predetermined navigation system body.

18. The navigation system according to claim 11, wherein
said image capturing apparatus further includes:
a map data reception part for receiving map data from said predetermined navigation system body in said connection state; and
a map data storage part for storing said map data received by said map data reception part, and
said image display part visibly outputs said map data stored in said map data storage part in a state where said connection state is canceled.

19. The navigation system according to claim 11, wherein
said image capturing apparatus further includes:
a voice data generation part for receiving voice generated by the user and generating voice data, wherein
in said connection state, voice data generated by said voice data generation part and positional information obtained by said predetermined navigation system body is associated with each other and the resultant information is stored as voice guide information in a predetermined voice guide information storage part.

20. The navigation system according to claim 11, wherein
said image capturing apparatus further includes:
a power reception part for receiving supply of power from said predetermined navigation system body in said connection state; and
an accumulation part for accumulating said power received by said power reception part, and
said accumulation part is included in a power source of said image capturing apparatus.
